(19) United States
(12) Patent Application Publication
(10) Pub. No.: US 2008/0122275 A1
(43) Pub. Date: May 29, 2008

(54) Backrest For a Vehicle Seat

(75) Inventors: Gerhard Flory, Annweiler (DE); Karl Pfahler, Stuttgart (DE); Lothar Renner, Nufringen (DE)

Correspondence Address: CROWELL & MORING LLP;INTELLECTUAL PROPERTY GROUP, P.O. BOX 14300, WASHINGTON, DC, 20044-4300, US

(73) Assignee: Daimlerchrysler AG, Stuttgart (DE)

(21) Appl. No.: 11/596,561

(22) PCT Filed: May 4, 2005
(86) PCT No.: PCT/EP05/04811

§ 371 Date: Aug. 7, 2007

(30) Foreign Application Priority Data
May 15, 2004 (DE) 10 2004 024 261.5

(51) Int. Cl. B60N 2/22

(52) U.S. Cl. 297/230.1

(57) ABSTRACT

A backrest for a vehicle seat has a rear wall and an integrated device for supplying hot air to the shoulder, neck and head region of a seated person. The device has at least one air duct leading to an air discharge opening, a fan housing, which accommodates a fan and is connected on the delivery side to the air duct and has an air intake opening connected to an air inlet opening in the rear wall, and a heating element, which is arranged in the air flow of the fan. In order for the hot air supply device to take up less empty space in the backrest and for it to be able to be fitted simply and rapidly, the air duct and the fan housing are combined to form a single-piece module arranged on the inner surface of the rear wall.

### BACKGROUND AND SUMMARY OF THE INVENTION

This invention relates to a backrest for a vehicle seat.

In a known vehicle seat for a two-seated, open vehicle with a wind protection device (see German document DE 100 47 754 A1), the hot air supply device, which is integrated in the backrest and is intended for the shoulder, neck and head region of a person sitting on the seat, has an air-distributing device. The air-distributing device is supported by the struts of the backrest frame and has three air ducts, of which one leads to an air discharge opening embedded in the upper narrow side of the backrest. The three air ducts are based in the common fan housing in which the fan is accommodated. On the suction side of the fan, an air supply connecting branch opening at an air inlet opening in the rear wall is provided. A heating element is arranged in each air duct. Alternatively, a single heating element is integrated in the fan housing.

In modern vehicle seats with motor-driven seat adjustment devices, multi-contour functions for adapting the contour of the seat, exit aids and seat ventilation, the free space remaining in the backrest between seat frame and rear wall, also referred to as backrest covering part or backrest trim panel, is virtually entirely occupied by units, and so it is structurally difficult to place the hot air device for ventilating the head space in the seat frame in an installation-friendly manner.

The present invention has as one object the object of integrating, in a backrest for a vehicle seat of the type mentioned, the hot air supply device for the shoulder, neck and head region of the seated person in the backrest in such a manner that it takes up less empty space in the region of the backrest and can be fitted simply and rapidly.

This object is achieved according to the claimed invention.

One advantage of the backrest according to the invention is that, by means of the hot air supply device being designed as a complete hot air module arranged on the inner surface of the rear wall, the installation of the components of the hot air module can be undertaken separately from the backrest and is not obstructed by the other units present in the backrest. The hot air module finally fitted to the rear wall is then installed by the rear wall, which covers the rear side of the backrest, being fitted into the backrest. By means of corresponding shaping of the rear wall, the space required by the hot air module in the interior of the backrest can be minimized. Easy retrofitting of a vehicle seat with hot air ventilation of the head space is possible by interchanging the rear wall. The time expended on removal is likewise low, with the result that costs for any possible repair of the hot air module remain low.

Advantageous embodiments of the backrest according to the invention with expedient developments and refinements of the invention are also claimed.

According to an advantageous embodiment of the invention, the air inlet opening, which is formed in the rear wall and is connected to the air intake opening of the hot air module, is arranged in the vicinity of the lower end of the rear wall. This has the advantage that the fan already sucks up hot air from the foot region of the vehicle interior, which air is at a higher temperature in an air-conditioned interior, so that, particularly when traveling with the top open in cold surroundings, the shoulder, neck and head region of the seated person is very much more rapidly supplied with hot air.

The invention is described in more detail below with reference to an exemplary embodiment illustrated in the drawings.

### BRIEF DESCRIPTION OF THE DRAWINGS

FIG. 1 shows a side view of a backrest of a vehicle seat with a head restraint and a hot air module for supplying hot air to the shoulder, neck and head region of a seated person,

FIG. 2 shows a reduced rear view of the backrest in FIG. 1 with the head restraint removed,

FIG. 3 shows an enlarged illustration of the detail III in FIG. 1 of a backrest with a modified hot air module, and

FIG. 4 shows a section along the line IV-IV in FIG. 1 of a backrest with a modified hot air module.

### DETAILED DESCRIPTION OF THE INVENTION

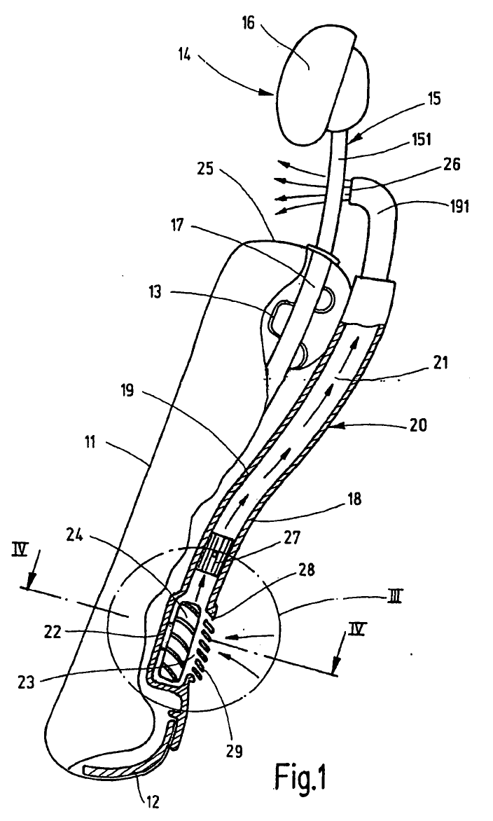

The backrest of a vehicle seat that is illustrated in schematized form in FIG. 1 in a side view and partially cut away has, in a known manner (not illustrated here), a backrest frame in which a cushion support is fixed, and a backrest cushion resting on the cushion support. The backrest cushion is covered by a cushion cover which is fixed to the backrest frame or to a function frame held on the backrest frame. Of the function frame, only a lower section 12 and an upper section 13 are illustrated in FIG. 1. A head restraint 14 comprises, in a known manner, a U-shaped supporting hoop 15 with two parallel supporting rods 151 and a transverse web connecting the two supporting rods 151 and a head cushion 16 arranged on the transverse web. In order to adjust the height of the head restraint 14, the supporting rods 151 are held in an axially displaceable manner within the backrest in guide tubes 17 which are fastened to the function frame. The rear side of the backrest is covered by a rear wall 18 which is fastened to the function frame—or to the backrest frame if the function frame is omitted.

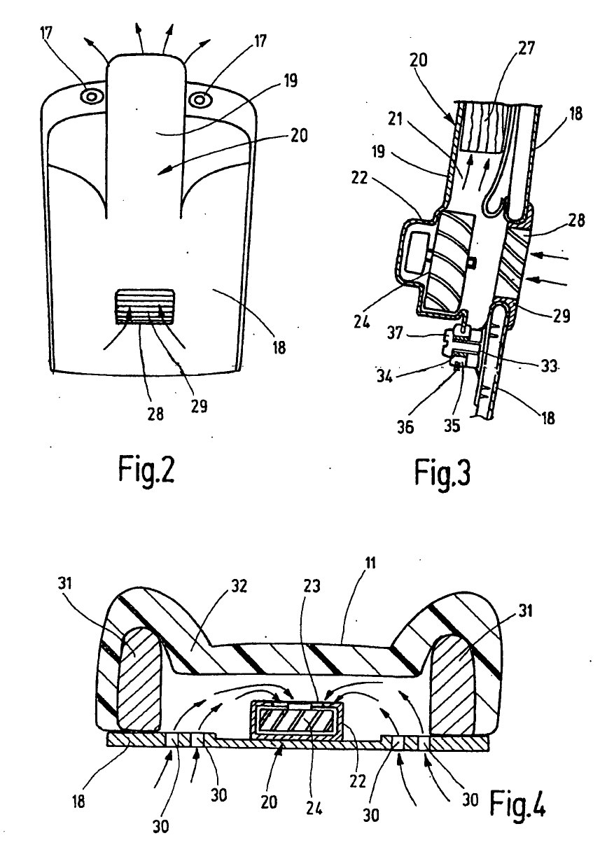

For ventilation of the head space with hot air, in particular for heating the shoulder, neck and head region of a seated person when traveling with the top open in cold surroundings, a hot air module 20 is arranged on the inner surface of the rear wall 18 and has a module housing 19 in which an air duct 21 and a fan housing 22, which is in a single piece with the latter, are formed. In the exemplary embodiment of FIG. 1, the module housing 19 is in a single piece with the rear wall 18, with the module housing 19 being integrally formed as a plastic injection-molded part during production of the rear wall 18. The module housing 19 has, in the region of the fan housing 22, an air intake opening 23 for a fan 24 arranged in the fan housing 22. The fan housing 22 merges into the air duct 21 on the delivery side of the fan 24. The module housing 19 protrudes with its air-duct end over the upper side 25 of the backrest and merges into a bend 191 which, on the end side, has an air discharge opening 26 which is directed toward the front side of the backrest and lies in the region between the upper side 25 of the backrest and the lower edge of the head cushion 16. An electric heating element 27 which heats the air blown by the fan 24 into the air duct 21 is arranged in the vicinity of the fan housing 22 in the air duct 21. The region of the module housing 19 that is on the fan-housing side covers an air inlet opening 28 which is arranged in the vicinity of the lower end of the backrest, is formed in the rear wall 18 and is covered by a decorative grille 29 (FIG. 2). In the exemplary embodiment of FIGS. 1 and 2, the air intake opening 23 is arranged in the module housing 19 of the hot air module 20 in such a manner that it is congruent with the air inlet opening 28. The air inlet opening 28 can alternatively also be formed by a perforated region of the rear wall 18.

In the exemplary embodiment of FIG. 4, the air intake opening 23 is arranged in the module housing 19 of the hot air module 20 in such a manner that it faces away from the rear wall 18. The air inlet opening 28 in the rear wall 18 is divided into a plurality of inlet holes 30 which are arranged in the rear wall 18 in the immediate vicinity of the hot air module 20 close to the air intake opening 23 thereof. Furthermore, in the exemplary embodiment of FIG. 4, the module housing 19 of the hot air module 20 is not formed as a single piece with the rear wall 18 but rather the hot air module 20 is fitted as a separate component to the rear wall 18 and is connected fixedly thereto. FIG. 4 additionally schematically illustrates the backrest frame with its side struts 31 and the backrest cushion 32 and the cushion cover 11 covering the backrest cushion 32.

The exemplary embodiment of FIG. 3 illustrates a preferred embodiment of the fastening of the hot air module 20, which is designed as a separate component, to the rear wall 18. In this case, the illustration in FIG. 3 corresponds to the detail III in FIG. 1, with only the hot air module 20 being modified insofar as it is a separate component from the rear wall 18 and is connected fixedly thereto by means of an additional installation operation. The module housing 19 of the hot air module 20 again uses its part forming the fan housing 22 to cover the air discharge opening 26, which is arranged in the rear wall 18 and is covered by a decorative grille 29, in such a manner that the air intake opening 23 of the hot air module 20 is congruent with the air inlet opening 28 in the rear wall 18. Fastening elements 33 on which the hot air module 20 is fixed with the interposition of a rubber sleeve 34 are provided in the rear wall 18. In the exemplary embodiment of FIG. 3, the rubber sleeve 34 is inserted into a receiving ring 35 which is clipped into a flange 36 formed on that part of the module housing 19 which is on the fan-housing side. A cap screw 37 which is screwed in the fastening element 33 is guided through the rubber sleeve 34 in the receiving ring 35. When the hot air module 20 is designed as a separate component which can be detached from the rear wall 18, the rear wall 18 is formed at its upper end in such a manner that the upper end of the module housing 19 can be led with the bend 191, which protrudes over the backrest, out of the rear wall 18 fastened to the function frame or backrest frame.

1-11. (canceled)

12. A backrest for a vehicle seat, comprising:
a rear wall, and
an integrated device for supplying hot air to the shoulder, neck, and head region of a seated person,
wherein said device has at least one air duct leading to an air discharge opening, a fan, which is connected on a delivery side to the air duct, within a fan housing which is connected via an air intake opening to an air inlet opening in a rear wall, and a heating element which is arranged in an air flow of the fan, and
wherein the integrated device, with the air duct and the fan housing combined to form a single-piece module housing, is designed as a complete hot air module arranged on an inner surface of the rear wall.

13. The backrest as claimed in claim 12, wherein the module housing protrudes over an upper side of the backrest and merges into a bend surrounding the air discharge opening which points toward a front side of the backrest.

14. The backrest as claimed in claim 12, wherein the air inlet opening is arranged in a vicinity of a lower end of the rear wall.

15. The backrest as claimed in claim 12, wherein the air intake opening of the hot air module is arranged in an immediate vicinity of the air inlet opening in the rear wall.

16. The backrest as claimed in claim 12, wherein the air inlet opening is covered by a decorative grille.

17. The backrest as claimed in claim 12, wherein the air inlet opening is formed by a perforated zone in the rear wall.

18. The backrest as claimed in claim 12, wherein the module housing covers the air inlet opening in such a manner that its air intake opening is congruent with the air inlet opening.

19. The backrest as claimed in claim 15, wherein the air intake opening is arranged on a side of the module housing which faces away from the rear wall, and wherein the air inlet opening in the rear wall is divided into a plurality of inlet holes, which are arranged in an immediate vicinity of the hot air module close to the air intake opening.

20. The backrest as claimed in claim 12, wherein the hot air module is fastened to the rear wall.

21. The backrest as claimed in claim 20, wherein fastening elements, on which the hot air module is fixed, are embedded in the rear wall.

22. The backrest as claimed in claim 12, wherein the module housing is designed as a single piece with the rear wall.

23. The backrest as claimed in claim 21, wherein the hot air module is fixed on the fastening elements via rubber sleeves.

24. The backrest as claimed in claim 13, wherein the air inlet opening is arranged in a vicinity of a lower end of the rear wall.

25. The backrest as claimed in claim 13, wherein the air intake opening of the hot air module is arranged in an immediate vicinity of the air inlet opening in the rear wall.

26. The backrest as claimed in claim 14, wherein the air intake opening of the hot air module is arranged in an immediate vicinity of the air inlet opening in the rear wall.

27. The backrest as claimed in claim 13, wherein the air inlet opening is covered by a decorative grille.

28. The backrest as claimed in claim 14, wherein the air inlet opening is covered by a decorative grille.

29. The backrest as claimed in claim 15, wherein the air inlet opening is covered by a decorative grille.

30. The backrest as claimed in claim 13, wherein the air inlet opening is formed by a perforated zone in the rear wall.

31. The backrest as claimed in claim 14, wherein the air inlet opening is formed by a perforated zone in the rear wall.
